(19) United States
(12) Patent Application Publication
(10) Pub. No.: US 2014/0048307 A1
(43) Pub. Date: Feb. 20, 2014

(54) CABLE-TERMINATION DEVICE

(71) Applicants: Jens Franke, Luegde (DE); Ralf Feldner, Detmold (DE); Manuel Tuenker, Doerentrup (DE); Cord Starke, Blomberg (DE)

(72) Inventors: Jens Franke, Luegde (DE); Ralf Feldner, Detmold (DE); Manuel Tuenker, Doerentrup (DE); Cord Starke, Blomberg (DE)

(73) Assignee: PHOENIX CONTACT GMBH & CO. KG, Blomberg (DE)

(21) Appl. No.: 14/110,439

(22) PCT Filed: Apr. 3, 2012
(86) PCT No.: PCT/EP2012/001505

§ 371 Date: Oct. 8, 2013

(30) Foreign Application Priority Data
Apr. 8, 2011 (DE) 102011016459.6

(51) Int. Cl. H01R 4/22

(52) U.S. Cl. CPC H01R 4/22
USPC 174/138 F

(57) ABSTRACT

A cable-termination device has a housing and an introduction opening for a cable, in order to terminate the cable end such that it is safe from contact. The housing includes a termination cap and a screw-connection unit interacting therewith. The introduction opening is provided in the screw-connection unit in a manner to accommodate at least one cable end. At least one latching device is provided for the purpose or latching the housing or the screw-connection unit to the termination cap.

### CROSS-REFERENCE TO PRIOR APPLICATIONS

This application is a U.S. National Phase application under 35 U.S.C. §371 of International Application No. PCT/EP2012/001505, filed on Apr. 3, 2012, and claims benefit to German Patent Application No. DE 10 2011 016 459.6, filed on Apr. 8, 2011. The International Application was published in German on Oct. 11, 2012, as WO 2012/136367 A2 under PCT Article 21(2).

### FIELD

The present invention relates to a cable-termination device, which is provided and suitable for terminating at least one cable end such that it is safe from contact.

### BACKGROUND

A cable end that is sealed from environmental influences such as dust and water is frequently needed in the assembly of photovoltaic systems, for example. Such cable-termination devices should generally meet at least protection class IP 67 in accordance with DIN EN 60529 or DIN 40050 Part 9 respectively. That means that the cable-termination device is constructed such that it is dustproof and at least provides protection against intermittent submersion of the cable-termination device in water, since such conditions may occur when cables are laid in the open air, for example when used in photovoltaic systems. Apart from their use in photovoltaic systems the use of the cable-termination device according to the invention is also possible in other electrical or electronic components.

To simplify the assembly of photovoltaic systems the power cables can be manufactured for example with T-pieces directly on the reel at regular intervals in order to make it easier to make up and connect solar modules later. Then such a cable has for example T-pieces at pre-determined intervals such as 1 m or similar to connect solar modules. In order to assemble solar modules it is then simply necessary to unroll the desired length of solar cable from the reel and cut it to the desired length. During the ensuing assembly the solar modules can then be connected laterally to the T-pieces that have already been provided.

However, it is important that the free end of the solar cable that has been cut off is terminated reliably. Due to the potentially high current strength and voltage in photovoltaic systems, it is important for the power cables to be terminated in a permanently reliable manner and such that they are safe from contact.

Because with the increasing installation of photovoltaic systems on the roofs of private individuals inexperienced people are increasingly gaining access to such electrical systems, it is important to terminate such solar cables such that the inhabitants or owners of a house equipped with a photovoltaic system are exposed to as little danger as possible.

The unpublished DE 10 2010 047 217.4-34 discloses a cable-termination device for the simple termination of cable ends, it no longer being possible to open the cable-termination device by hand following completion of the assembly.

### SUMMARY

In an embodiment, the present invention provides a cable-termination device including: a housing; a latching device; and an introduction opening configured to accommodate a cable so as to terminate an end of the cable such that the end is safe from contact, wherein the housing comprises a termination cap and a screw-connection unit interacting with the termination cap, wherein the introduction opening is provided on the screw-connection unit to accommodate at least one cable end, wherein the latching device is configured to latch the screw-connection unit to the termination cap.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a view of a cable-termination device according to the invention;

FIG. 2 shows an exploded view of a cable-termination device according to FIG. 1;

FIG. 3 shows a plan view of the termination cap of the cable-termination device according to FIG. 1;

FIG. 4 shows a cross section through the cable-termination Device according to FIG. 1;

FIG. 5 shows a cable-termination device according to FIG. 1 during assembly;

FIG. 6 shows a cable-termination device during a further assembly stage;

FIG. 7 shows a further cable-termination device;

FIG. 8 shows the screw-connection unit of the cable-termination device according to FIG. 7;

FIG. 9 shows the termination cap according to FIG. 7 in a perspective view; and

FIG. 10 shows a plan view of the termination cap according to FIG. 9.

### DETAILED DESCRIPTION

The present invention provides a further cable-termination device that is simple to assemble and which provides reliable protection from contact.

The cable-termination device according to the invention has a housing with at least one introduction opening for a cable in order to terminate the cable end such that it is safe from contact.

The housing has a termination cap and a screw-connection unit interacting therewith. The introduction opening is provided in the screw-connection unit for the purpose of accommodating at least one cable end. At least one latching device is provided for the purpose of latching the housing. In particular the latching device serves to latch the screw-connection unit to the termination cap.

The cable-termination device according to the invention has many advantages, because it provides simple assembly and a high degree of safety. Dismantling by hand is not possible without an additional tool due to the latching device. A hand cannot grip sufficiently to dismantle it without the use of a tool. Thus the cable-termination device according to the invention provides a high degree of safety in a simple manner, in particular when used on solar cables for photovoltaic systems. Inexperienced persons who get hold of such a cable-termination device cannot open the cable-termination device without a special tool.

In preferred developments the latching device comprises at least one latch tooth system and at least one latch element interacting therewith. The use of a latch with a latch tooth system and at least one latch element interacting therewith facilitates reliable latching of the cable-termination device. Preferably the tooth system is constructed as an axial tooth system and interacts with a corresponding latching element which acts axially.

It is particularly preferable for a radially acting latch tooth system to be provided, which is arranged radially on the housing.

Preferably at least one in particular elastic acting latching element is then provided on the termination cap. In all cases it is particularly preferable for a plurality of latching elements to be provided, which are arranged in particular distributed symmetrically over the circumference.

In advantageous embodiments the latching device comprises at least one helical tooth system. The helical tooth system has teeth, one edge of which is constructed such that it is considerably shallower than the other edge. It is also possible for one edge to be constructed so that it is shallow and the other edge to be orientated perpendicularly at an angle of 90° for example. It is also possible for the gradient of the edge to be larger than 90° resulting in a projection or indentation. Such embodiments facilitate a connection that is particularly difficult to release.

In principle, latching devices with latch tooth systems, where there is a particularly steep tooth edge for latching, can only be released using a large amount of strength. It is particularly preferable here for such a large amount of strength to be selected such that without the use of a tool a release of the connection would only be possible by destroying the latching device and thus the terminating device altogether.

In particularly preferable embodiments the helical toothing is engaged with the latching element at least temporarily and/or at least in portions during the screwing process. In the process the teeth of the helical toothing slope upwards at a lower gradient in the direction of screwing than in the opposite direction. In this way a simple screwing of the termination cap to the housing is possible.

The latching element and/or teeth of the helical toothing yield elastically during the screwing process. Once the termination cap has been successfully screwed in or on, the steeper progression of the teeth of the helical toothing on the other side means that it is only possible to unscrew it using a large amount of force, which generally leads to a destruction of the component.

In preferred embodiments the latch toothing is arranged radially on the exterior of the housing. It is, however, also possible for the latch toothing to be provided radially on the interior along a circumferential contour or a circumferential recess. The latching element, of which there is at least one, is accordingly provided either radially on the exterior or radially on the interior in order to guarantee engagement with the latch toothing.

If the termination cap is constructed such that it is rounded on the outermost end then this allows even more reliable and permanent protection from accidental or unintentional opening of the cable-termination device as a result of the shape of the termination cap even if the typically plastic housing sections such as termination cap and screw unit should be subject to settlement.

Protective devices for cable ends such as junction boxes have become known in prior art. In these, individual entries are sealed using sealing plugs. These can, however, also be opened without a tool so that private individuals who are not aware of the dangers of opening the cable-termination devices on photovoltaic systems may be exposed to a considerable risk.

Another disadvantage is the matter of the cost of such components and the substantially higher outlay for assembly. Here, the invention provides the advantage of lower outlay for assembly and the additional advantage of lower costs as well as improved protection from contact.

In a preferred development a locking device, which may be gripped by a tool, is provided on the outer end of the termination cap. A locking device on the outer end of the termination cap offers the advantage that the termination cap can be held by a tool, which has gripped the locking device, while the screw unit is screwed. When the screwing process is complete the tool can be removed so that it is not possible to re-open it subsequently without a tool.

Preferably, the locking device comprises at least one slit and/or through-hole, which extends transverse to the longitudinal extension of a cable that is to be terminated. A tool such as a screwdriver may, for example, be inserted through a through-hole and thus used to fix the position. The screw unit can be rotated towards the termination cap, which is fixed in place, in order to close the housing of the cable-termination device and terminate the cable accommodated therein such that it is safe from contact.

Preferably, the termination cap on the outer end is constructed such that it is approximately spherical. Such a spherical embodiment offers advantages, since the fixing of the spherical end of the termination cap by hand is only possible with great difficulty. An accidental opening of the cable-termination device is therefore practically impossible.

The termination cap preferably has an external thread along at least one longitudinal portion. In particular the screw unit has an internal thread along at least one longitudinal region. It is particularly preferable for the internal thread of the screw unit to interact with the external thread of the termination cap in order to screw the housing of the cable-termination device together.

Preferably at least one splice ring is accommodated at least partially inside the termination cap.

It is possible for the sealing cap to have a clamping device with at least one clamping contour and/or for the splice ring to have at least one clamping groove. It is particularly preferable for the clamping contour of the termination cap to interact with the clamping groove in the splice ring.

At the same time it is particularly preferable for it to be possible for at least one core of the cable or the cable as a whole to be accommodated by clamping between the clamping contour and the clamping groove. This achieves a particularly advantageous fixing of the cable end to the cable-termination device, since the splice ring, which has been arranged in between the screw unit and the termination cap when they are screwed together, reliably clamps the accommodated cable end together with the termination cap.

It is particularly preferable for a plurality of clamping contours and a plurality of clamping grooves to be arranged distributed along the circumference in a defined manner. This makes it possible, for example, for a multi-core cable to be clamped safely and reliably, each individual core of the cable being clamped to a pair of clamping contour and clamping groove. It is particularly preferable for the clamping contours to be arranged in star formation so that the individual cores of a multi-core cable extend from the centre in star formation. As a result, particularly large creepage distances between the individual cable ends are enabled, which adds to the safety.

The clamping grooves can be constructed such that they are U-shaped or V-shaped in particular and serve to accommodate the core ends, which are clamped there by corresponding clamping contours in the form of profiles or similar. The distribution of the clamping contours and clamping grooves can be provided such that they are distributed symmetrically about the circumference. It is possible for the individual clamping grooves and clamping contours to be provided such that they are equidistant to each other. It is also even possible for individual clamping contours to be arranged in groups, the distance of the individual groups from each other being larger than the distance between individual cores in a group.

Another configuration is particularly preferable where the splice ring has at least one clamping groove. A core end of the cable is deflected by about 180° at this clamping groove. As a result, the core of the cable is accommodated such that it is very reliably clamped. A deflection of about 180° facilitates a particularly strong clamping and secure position in the case of the solar cables, which are very substantial. It is practically impossible to pull the cable out, since the cable is deflected by 180° and it would be impossible to muster the necessary strength to pull it out like that or it would lead to the destruction of the component.

A particular advantage of such a clamping groove, in particular a U-shaped one, with a 180° deflection is that it is not necessary to provide a clamping contour in the termination cap.

The termination cap encloses the core ends at the splice ring in assembled state. During assembly the termination cap ensures that the core ends are deflected by about 180° when it is pushed on.

As a result, the splice ring can be filled into the termination cap with any desired angles. An adjustment of the angle of rotation is not necessary. If, on the other hand, a clamping contour is used in the termination cap, the termination cap can only be assembled with pre-determined angles, since the position of the clamping contour and clamping groove must match.

In all of the embodiments preferably at least one sealing device is provided between the splice ring and the termination cap. The sealing device can, for example, comprise at least one o-ring or be constructed as such.

Preferably, a sealing unit is arranged radially inside the splice ring. In particular the sealing unit is provided between the cable and the inner contour of the splice ring.

The screw-connection unit can have at least one sealing cone, which compresses a lamellar structure of the splice ring when the screw connection unit is screwed to the termination cap, so that the sealing unit is pressed against an inserted cable end inside the splice ring thus protecting the cable end from the entry of water and dust and such like.

A high degree of reliability and safety is created through the splice ring, which clamps the cable as a whole or individual cores thereof separately. Even with great force a cable cannot be pulled out of the cable-termination device without any additional help. Furthermore the cable-termination device according to the invention can be assembled cost effectively and simply.

To assemble, a section of the cable jacket can be removed and the screw part and the splice ring are pushed onto the cable end. The individual cores are fixed in the clamping grooves and the protruding ends can simply be cut off. Subsequently, the termination cap is pushed on and fixed at an angle using a screwdriver or similar while the screw part is screwed to the termination cap. As a result, the individual cores are deflected by 180° to the clamping grooves and clamped there, thus resulting in a very tight fit of the cable end at the cable-termination device. The deflection by about 180° allows a very tight fit. “About 180°” is to be understood to be a region of between 150° and 210° and in particular between 165° and 195°.

Once assembly is complete, the screwdriver may be removed and dismantling is not possible without a tool.

As a result of the star formation splicing and subsequent bending back of the cores, the open core ends are brought as far apart from each other as possible such that reliable protection and the best possible air and creepage gaps are provided.

The present invention is also aimed at a cable-termination device, which has a housing with an introduction opening for a cable in order to terminate the cable end such that it is safe from contact. The housing here comprises a termination cap and a screw-connection unit interacting therewith. The introduction opening is provided in the screw-connection unit for the purpose of accommodating at least one cable end. At least one core end of the cable end is deflected here by about 165° to 195° and in particular by about 180° in order to achieve a tight fit.

This cable-termination device has many advantages, since it allows the tight fit of a single- or multi-core cable. A costly and time-consuming configuration of clamping grooves and clamping contours interacting with each other is not necessary. It is sufficient for the deflection at, for example, one U-shaped clamping groove to reliably clamp the core end.

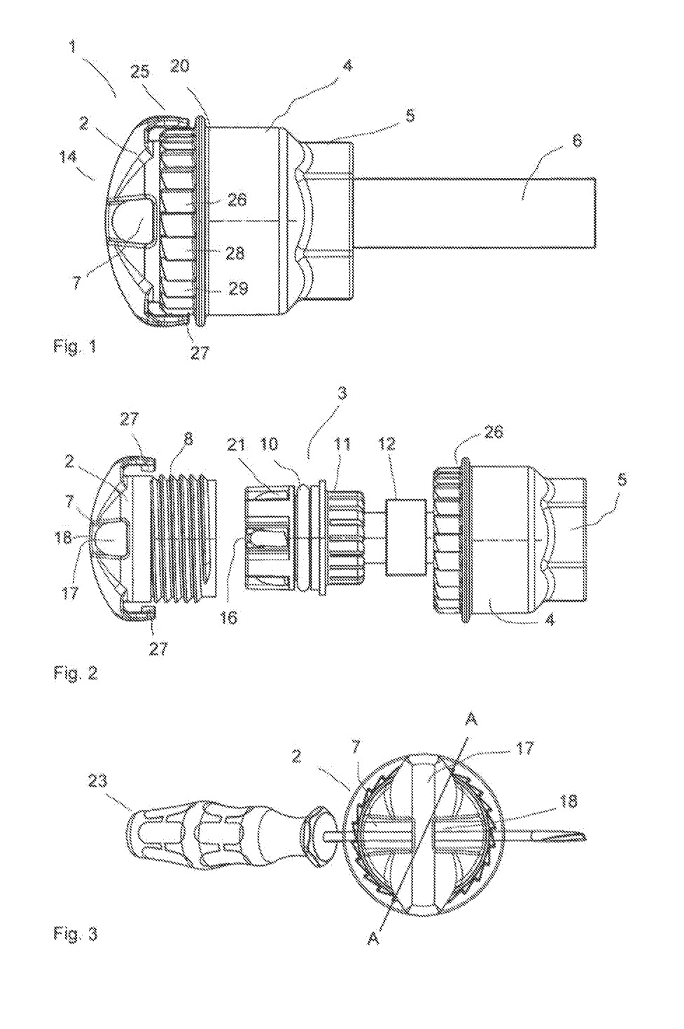

A first embodiment of the invention is described with reference to the accompanying drawings FIGS. 1 to 6, FIG. 1 showing a side view of a cable-termination device 1 according to the invention.

The cable-termination device 1 comprises a sealing cap 2 and a screw-connection unit 4, which are screwed together to terminate a cable 6. In order to increase protection from unintentional opening, a latching device 25 is provided, which in the embodiment here comprises latch toothing 26 and two latch elements 27 that are constructed as latch hooks.

The latch toothing 26 is constructed as helical toothing 28 and here in the first embodiment is provided radially on the exterior of the screw connection unit 4. The latch toothing 26 interacts with the latching elements 27, the latching elements 27 each engaging between two teeth 29 and ensuring secure latching there in the screwed state.

Once the screwing process of the termination cap 2 with the screw-connection unit 4 has been completed it is no longer possible to re-open it. The latching device 25 latches such that it is not possible to open it by hand. If opening does become necessary, the termination cap 2 can be unscrewed against the force of the latching device 25 with the aid of a tool 23, this regularly leading to a destruction of the latching device 25 and therefore of the whole cable-termination device 1.

If applicable, it is possible to bend the latching elements 27 away from the latch toothing 26 with the use of a tool and thereby bring the latching device out of its engaged state. Then the termination cap 2 can be screwed off again.

The termination cap 2 is preferably constructed such that it is spherical at the outer end 14 in order to provide even less resistance for a hand and to make it even harder to unintentionally open the cable-termination device.

Spanner flats 5 are provided on the cable-termination device or on the screw part or the screw-connection unit 4, which can be engaged with a spanner, pliers or another tool, in order to screw the screw-connection 4 to the sealing cap 2.

The screw-connection unit 4 together with the termination cap 2 forms the housing 20, which accommodates a cable end 13 of a cable 6 that is accommodated therein such that it is safe from contact and protects it reliably from contact, flashover or such like.

On the termination cap 2, a locking device 7 is provided, which has slits 17 that can be seen clearly in FIGS. 2 and 3 and a web 18. The slits 17 form a through-hole, which is covered by the web 18.

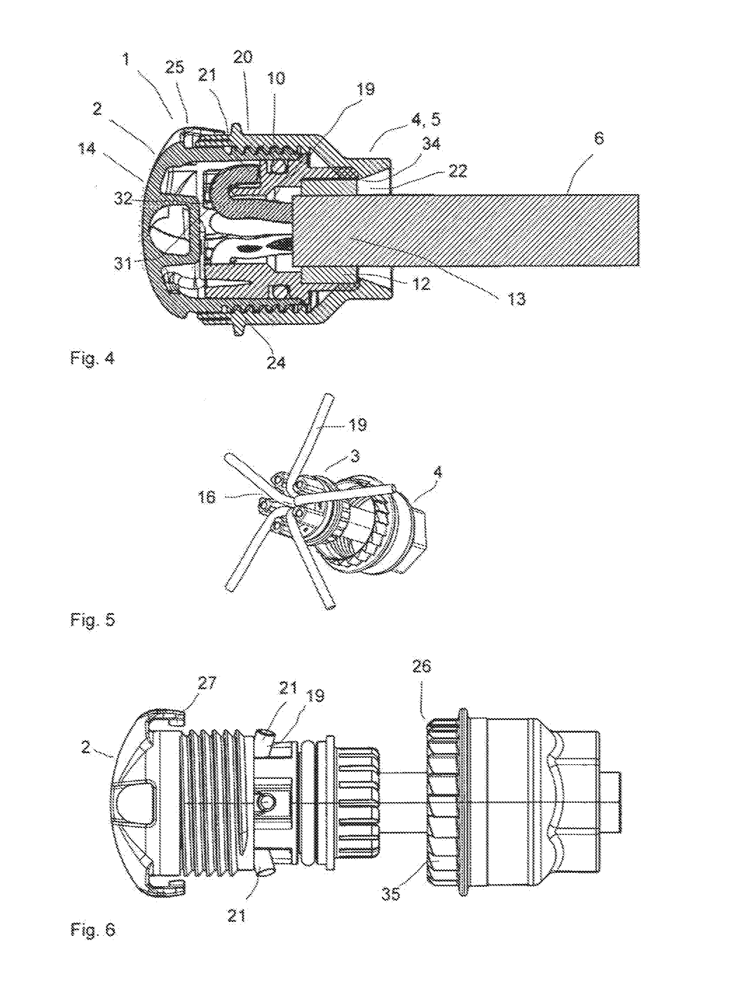

As shown in FIG. 2, the termination cap 2 has an external thread 8, which is provided in order to be screwed together with an internal thread 24 (cf. FIG. 4) of the screw-connection unit 4. Here a splice ring 3 is accommodated between the screw-connection unit 4 and the termination cap 2. Clamping grooves 16 are provided on the splice ring 3 in order to accommodate the ends 21 shown in FIG. 2 of the individual cores 19 of the cable 6 in the clamping grooves 16 such that they are clamped. An o-ring 10 serves as a sealing device to provide a seal from the termination cap 2.

On the end of the splice ring 3 that is turned towards the screw-connection unit 4 a lamellar structure 11 is provided, which interacts with the sealing unit 12 during the screwing process in order to accommodate the cable end 13 of the cable 6 at the screw-connection unit 4 so that it is sealed. The sealing unit 12 can be constructed as an elastic sealing ring.

In FIG. 4 a cross section A-A through the cable-termination device 1 according to FIG. 3 is shown. The core ends 21 of the individual cores 19 of the cable 6 are clamped to the clamping grooves. The core ends 21 are reliably clamped to the clamping grooves 16 in the splice ring 3.

The clamping action is secured by the 180° deflection.

The sealing unit 12, which is pressed by the compressed lamellar structure 11 onto the cable end 13, serves to seal the cable end 13 from the screw-connection unit 4.

When the screw-connection unit 4 is screwed together, the external thread 8 of the termination cap 2 is screwed into the internal thread 24 of the screw-connection unit 4. Before the screwing process the cable end 13 is pushed into the introduction opening 22.

FIG. 3 shows the cable-termination device 1 during assembly, a tool 23 being inserted through the locking device 7 so that the screw-connection unit 4 can be screwed together with the termination cap 2.

Further steps of the assembly are shown in FIGS. 5 and 6. The assembly is described hereinafter with reference to these drawings. During assembly, the cable end 13 of the cable 6 is pushed through the introduction opening 22 of a screw-connection unit 4. Then the cable end 13 is fed through the splice ring 3. The individual cores 19 are exposed and tucked into the clamping grooves 16 of the splice ring 3. The protruding ends of the individual cores 19 are cut off to fit.

As shown in FIG. 6, the screw-connection unit 4 is then pushed on. Next the termination cap 2 is screwed into the internal thread 24 with its external thread 8 (cf. FIG. 4). In the process, a deflection of the core ends 21 of the individual cores 19 is caused by the housing region in the region of the thread 8 of the termination cap 2. The forces caused by the screwing process are so great that the solid conductors in the core ends 21 are deflected at the clamping grooves 16 by 180°. As a result, the cut off ends point back in the direction of the screw-connection unit 4. The freely exposed core ends are as far apart as possible from the outer end 14.

As a result of this deflection by about 180°, the distance to the outer end 14 of the termination cap 2 is again increased. If the termination cap 2 should be damaged for any reason through force or such then there is still a considerable distance from the end of the conductors at the core ends 21, which are accessible in the event of damage, even if the termination cap 2 has been opened or removed. As a result, finger contact can be largely prevented even in the event of damage.

The cutting of the core ends 21 is done here so that a deflection of 180° is guaranteed. In addition, the deflection by 180° guarantees a tight clamping fit to the cable-termination device. The length that has been deflected by 180° can, for example, be 5 mm or 100 m. In particular it is greater than double the diameter of the core end 21.

When the termination cap 2 is screwed together with the screw-connection unit 4, the latching elements 27 engage with the latch toothing 26, which is constructed as helical toothing 28 here.

The latching elements 27 are constructed such that they are elastic to the extent that when the latching elements 27 are slid over the shallower slants 35 of the teeth 29 there is an elastic shrinking back in an outwardly radial direction.

Once the respective slants 35 have been surmounted, the latching elements 27 spring elastically back in an inwardly radial direction so that it is practically impossible to unscrew the device in the opposite direction of rotation.

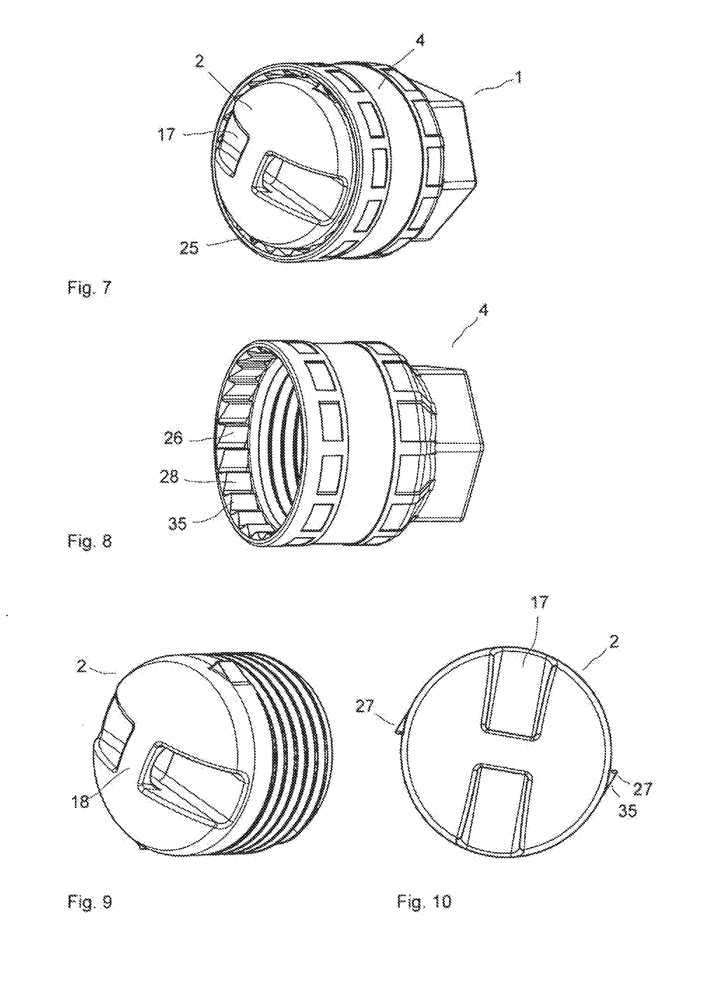

While the latching device 25 in the embodiment according to FIGS. 1 to 6 is constructed with latch toothing 26 provided radially on the outside and latching elements 27 acting radially inwards, the latch toothing 26 of the embodiment according to FIGS. 7 to 10, which is constructed as helical toothing 28, is arranged on a radial internal contour or on an internal section of the screw-connection unit 4. The latching elements 27 are provided radially on the exterior of the termination cap 3.

The termination cap 2 is screwed together with the screw-connection unit 4 for a sealed accommodation and termination of a cable 6. After a certain number of screw rotations, the latching elements 27 engage with the helical toothing 28. In the process the shallow slants 35 of the latching elements 27 slide onto the shallow slants 35 of the teeth 29, the latching elements 27 bending, for example, elastically. As a result of the slants 35 being provided with a shallower gradient in the direction of screwing, the screwing process can be carried out with little force. Once the screwing process is complete, the latching elements 27 latch tight with the helical toothing 28 so that it is not possible to unscrew it again by hand.

The effect of the latch can only be overcome with great force using a tool 23, as shown in FIG. 3, which regularly leads to a destruction of the component. It may be possible to open it with a special tool without destroying it.

On the whole, a high degree of protection from contact can be guaranteed through the deflection of the core ends 21 by about 180°. The locking of the housing components 2 and 4 to each other leads to a safe closure of the cable-termination device 1.

At the same time, particularly simple assembly is facilitated, where no special tool has to be used. Thus the assembly of photovoltaic systems on roofs can be carried out with little outlay.

The locking device 7 on the termination cap 2 can be of any shape in principle. For example, it is also possible for two holes to be provided at a distance from each other in the termination cap, into which a tool is inserted so that it is possible to fix the termination cap to prevent rotation.

The cable-termination device according to the invention facilitates a high degree of tightness against the penetration of water and dust since a high degree of tightness can be achieved through the sealing of the splice ring against the exterior using an o-ring, for example. Furthermore, a high degree of tightness is also achieved between the cable end 13 and the splice ring through the sealing unit, which is rubbery-elastic, for example.

The invention provides many advantages, since a high degree of tensile strength may also be achieved. The clamping of the individual cores between the splice ring and the termination cap allows a high degree of tensile strength. At the same time, fixing of the individual cores using screws, springs or similar is dispensed with. It is possible to use simple plastic parts, which are sealed using standardised seals.

A tool is necessary to open it again, even if a certain settlement process has set in with the plastic parts that have been used.

By using a star formation arrangement of the individual cores, particularly large air and creepage gaps are provided.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

Cable-termination device 1

Termination cap 2

Splice ring 3

Screw-connection unit 4

Spanner flats 5

Cable 6

Locking device 7

External thread 8

Sealing device, o-ring 10

Lamellar structure 11

Sealing unit 12

Cable end 13

Outer end 14

Clamping groove 16

Slit 17

Web 18

Individual core 19

Housing 20

Core end 21

Introduction opening 22

Tool 23

Internal thread 24

Latching device 25

Latch toothing 26

Latching element 27

Helical toothing 28

Tooth 29

Contour, recess 30

Clamping device 31

Direction of screwing 33

Sealing cone 34

Slants 35

1: A cable-termination device, comprising:
a housing;
a latching device; and
an introduction opening configured to accommodate a cable so as to terminate an end of the cable such that the end is safe from contact,
wherein the housing comprises a termination cap and a screw-connection unit configured to interact with the termination cap,
wherein the introduction opening is provided on the screw-connection unit to accommodate at least one cable end,
wherein the latching device is configured to latch the screw-connection unit to the termination cap.

2: The cable-termination device of claim 1, wherein the latching device comprises
a latch toothing system and
a latching element interacting with the latch toothing system.

3: The cable-termination device of claim 2, wherein the latch toothing system is provided radially on the housing, and
wherein the elastic latching element is provided on the termination cap.

4: The cable-termination device of claim 1, wherein the latching device comprises a helical toothing system.

5: The cable-termination device of claim 4,
wherein the helical toothing system engages with the latching element at least in portions when it is screwed, and
wherein teeth of the helical toothing system rise at a shallower gradient in the direction of screwing than in the opposite direction.

6: The cable-termination device of claim 1, further comprising:
a latch toothing system arranged radially on an exterior of the housing.

7: The cable-termination device of claim 1, further comprising:
a latch toothing system arranged radially on an interior along a circumferential contour.

8: The cable-termination device of claim 1, wherein the termination cap comprises an external thread over at least one longitudinal portion.

9: The cable-termination device of claim 1, wherein the termination cap comprises a splice ring, the splice ring being accommodated at least partially inside the termination cap.

10: The cable-termination device of claim 1, wherein the termination cap comprises a splice ring,
wherein the splice ring comprises clamping groove at which at least one core end of the cable is deflected by about 180°, in order to accommodate a core of the cable such that the core is clamped.

11: The cable-termination device of claim 1, further comprising:
a sealing unit provided between a splice ring and the termination cap.

12: The cable-termination device of claim 1, wherein the screw-connection unit further comprises a sealing cone, and
wherein a lamellar structure of the splice ring is compressed when the screw-connection unit is screwed together with the termination cap so that the sealing unit is pressed against an inserted cable end.

13: A cable-termination device, comprising:
a housing; and
an introduction opening configured to accommodate a cable so as to terminate an end of the cable, such that the end is safe from contact,
wherein the housing comprises a termination cap and a screw-connection unit interacting with the termination cap,
wherein the screw-connection unit comprises the introduction opening, so as to accommodate at least one cable end, and
wherein at least one core end of the end of the cable is deflected by about 180° in order to achieve a tight fit.

14: The cable-termination device of claim 1, wherein the screw-connection unit includes an internal thread in at least one longitudinal region.

15: The cable-termination device of claim 8, wherein the screw-connection unit includes an internal thread in at least one longitudinal region.

16: The cable-termination device of claim 1, wherein the termination cap comprises a splice ring,
wherein the splice ring comprises a sealing unit, and
wherein the sealing unit is arranged radially inside the splice ring.

17: The cable-termination device of claim 1, further comprising:
an o-ring provided between a splice ring and the termination cap.
